(19) United States
(12) Patent Application Publication
(10) Pub. No.: US 2007/0085358 A1
(43) Pub. Date: Apr. 19, 2007

(54) Pick-up tool with ergonomic handle

(76) Inventors: Earl F. Robinson, Lake Forest, CA (US); Scott L. Conway, Yorba Linda, CA (US); Joseph E. Merchant, Lake Forest, CA (US)

Correspondence Address: THE MAXHAM FIRM, 9330 SCRANTON ROAD, SUITE 350, SAN DIEGO, CA, 92121, US

(21) Appl. No.: 11/314,514

(22) Filed: Dec. 20, 2005

Related U.S. Application Data
(60) Provisional application No. 60/727,596, filed on Oct. 17, 2005.

(51) Int. Cl. B25J 1/00

(52) U.S. Cl. 294/19.1

(57) ABSTRACT

A handle for use with a pick-up tool includes first and second side panels, a pivoting trigger, an integrated grip, and a locking mechanism for selectively locking the trigger. The trigger extends through an upper housing of the side panels, and the grip extends from a rear section of the upper housing. The locking mechanism may include a pin located within a slot formed within the trigger, and a locking pawl that has notches which are sized to be received by the pin. The locking mechanism may also include a torsion spring that has a first leg for coupling to the locking pawl, and a sliding thumb tab that is located in the rear section of the upper housing. The thumb tab may contain an engagement structure for selectively engaging the first leg of the torsion spring. In use, downward sliding of the thumb tab causes one of the notches of the locking pawl to engage the pin and effectively lock the trigger.

### CROSS REFERENCE TO RELATED APPLICATIONS

This Application claims benefit of priority from provisional patent application Ser. No. 60/727,596, filed 17 Oct. 2005.

### BACKGROUND OF THE INVENTION

1. Field of the Invention

The present invention relates generally to a pick-up tool, and in particular to a pick-up tool having an ergonomic handle.

2. Discussion of the Related Art

There are a wide variety of tools designed for picking up objects or manipulating objects from a distance. One common application for such tools is use by maintenance workers to pick-up debris for subsequent disposal. A tool with an elongated handle allows manipulation of the object without the need to bend over or to directly handle the material. Such tools are also useful for individuals that have physical limitations that may impede their ability to bend over and reach the ground. There are also numerous household applications for such tools including retrieval of materials from high shelves or from under furniture. Another common application for these tools is for changing light bulbs from recessed lighting fixtures.

In general, pick-up tools include an elongated shaft having a handle and a control device on one end, and engagement elements on the opposite end. Some sort of linkage typically couples the engagement elements to the control element. The user of these tools may manipulate the controller, which may be constructed as a lever or trigger, to operate the engagement elements that are provided on the opposite end of the elongated shaft. The engagement elements may include arrangements such as claws, arms, scoops, calipers, tongs, blades or cups. In typical designs, a control lever or trigger pulls an internal linkage that draws together the engagement elements that are biased apart by springs.

### SUMMARY OF THE INVENTION

A handle for use with a pick-up tool includes first and second side panels, a pivoting trigger, an integrated grip, and a locking mechanism for selectively locking the trigger. The trigger extends through an upper housing of the side panels, and the grip extends from a rear section of the upper housing. The locking mechanism may include a pin located within a slot formed within the trigger, and a locking pawl that has notches which are sized to be received by the pin. The locking mechanism may also include a torsion spring that has a first leg for coupling to the locking pawl, and a sliding thumb tab that is located in the rear section of the upper housing. The thumb tab may contain an engagement structure for selectively engaging the first leg of the torsion spring. In use, downward sliding of the thumb tab causes one of the notches of the locking pawl to engage the pin and effectively lock the trigger.

### BRIEF DESCRIPTION OF THE DRAWING

The above and other aspects, features, and advantages of the present invention will become more apparent upon consideration of the following description of preferred embodiments, taken in conjunction with the accompanying drawing figures, wherein:

FIG. 1 is a perspective view of a pick-up tool in accordance with an embodiment of the present invention;

FIG. 2 is an exploded perspective view of the handle depicted in FIG. 1;

FIG. 3 is a side view of the interior of the side panel of the handle of FIG. 1;

FIG. 4 is a side view of the side panel of FIG. 3, showing various components contained therein;

FIG. 5 is a side view of the side panel of FIG. 4, showing the trigger in the fully pulled-back position, and contained within the recess of the grip;

FIGS. 6 and 7 are side and front views, respectively, of the trigger shown in FIG. 4;

FIGS. 8-10 are side views of various torsion springs that may be implemented in the handle of FIG. 1; and

FIG. 11 is a side view of a side panel containing several components of a locking mechanism, according to an alternative embodiment of the present invention.

### DETAILED DESCRIPTION OF PREFERRED EMBODIMENTS

In the following detailed description, reference is made to the accompanying drawing figures which form a part hereof, and which show by way of illustration specific embodiments of the invention. It is to be understood by those of ordinary skill in this technological field that other embodiments may be utilized, and that structural, as well as procedural, changes may be made without departing from the scope of the present invention. As a matter of convenience, various embodiments of the invention will be described using exemplary materials, sizes, shapes, and dimensions, but the present invention is not limited to the stated examples.

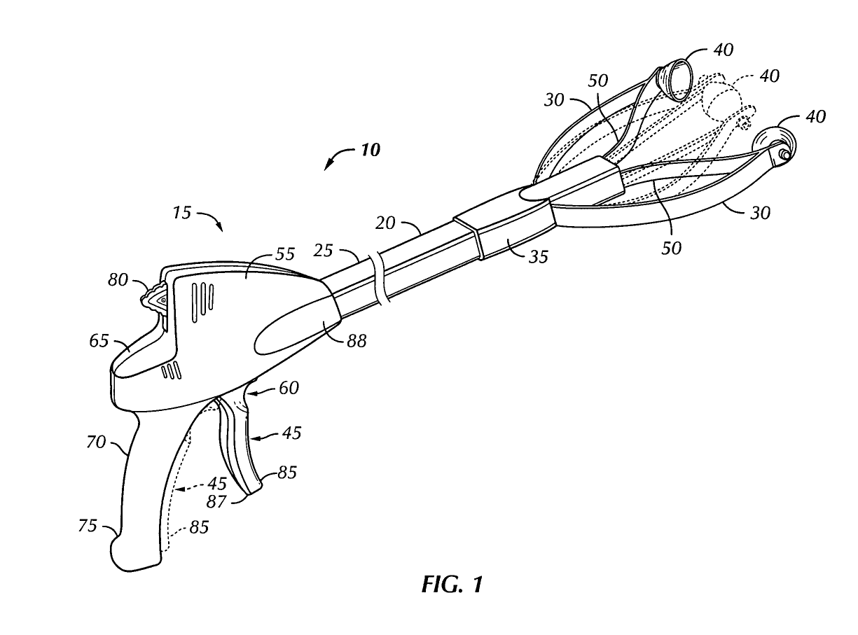

FIG. 1 is a perspective view of pick-up tool 10, which is shown having handle 15 attached to elongated hollow body 20 at proximal end 25. Optional first and second pick-up fingers 30 may be attached at their proximal ends to an outside portion of the body using a suitable fastening device or technique including rivets, welding, bolt and nut combinations, straps, clamps, and the like. If desired, cover 35 may be used to conceal the interface between the pick-up fingers and the body, and may additionally aid in the fastening of the pick-up fingers to the body.

In general, separate linkages respectively extend from each engagement element, shown in FIG. 1 as cups 40. Both cups are effectively coupled to trigger 45 using linkage components. For example, in the embodiment of FIG. 1, linkages 50 each extend from a separate cup and pass through at least a portion of the interior of body 20. Both linkages may be attached to a separate linkage component which passes through the hollow body and is coupled to trigger 45. Alternatively, linkages 50 may each directly couple to the trigger.

The trigger is shown extending through a lower portion of housing 55, and may be formed with a curved surface for receiving fingers of a user. The trigger may be pivotally mounted within the housing so that the trigger pulls linkages 50 rearward when the trigger is squeezed by a user. The trigger may further include recess 60, which is located proximate to a lower portion of the housing. Handle 15 may further include platform 65, which is shown formed in the rear section of housing 55. Integrated grip 70 extends from the housing, and may be formed with a cavity, recess, or other opening that is capable of receiving at least a portion of the trigger. Hand support 75 is an example of a protruding structure that is located at the distal end of the grip and extends rearward to support the user's hand. Optional thumb tab 80 is one component of a locking mechanism that may be used to secure the pick-up tool in various partially closed, or fully closed, positions.

Recess 60 provides a convenient and comfortable location for the user to place their index finger, for example, during operation of the pick-up tool. The recess allows the user to firmly engage trigger 45, and minimizes slipping that may occur between the user's fingers and the trigger. Another benefit provided by the recess is that the user's finger rests in the recess, below the lower surface of housing 55. This prevents or minimizes contact between the user's finger and the housing, thereby eliminating the occurrence of painful blisters and abrasions. Indeed, handle 15 allows users to forgo gloves without fear of suffering from such injuries. Although a single recess is shown, two, three, or four recesses may alternatively be formed in the trigger.

Platform 65 is often implemented to allow access to thumb tab 80 using, for example, the user's thumb. The platform also provides a stable structure for which a user may place their thumb while holding or operating the pick-up tool. In some situations, increased gripping power may be achieved by placing the thumb on the platform. Hand support 75 provides support to the bottom portion of a user's hand during operation or handling of the pick-up tool. The hand support also minimizes slipping that may occur between the user's fingers and the trigger, and between the user's palm and grip 70.

The engagements elements, such as cups 40, may be formed from an assortment of different materials which allows the pick-up tool to grasp or otherwise engage an item of interest such as, for example, trash, books, coins, clothing, food items, garden debris, and the like. Possible engagement elements include arrangements such as cups, claws, arms, scoops, calipers, tongs, blades, and the like. Suitable materials for the engagement elements include rubber, plastic, metal, and alloys, among others. In the embodiment illustrated in FIG. 1, the cups may have a diameter of about 0.5-2.5 inches, or more. However, the cups may be dimensioned to facilitate the retrieval of particular types of items such as cans, books, rocks, coins, golf balls, tennis balls, and the like.

Body 20, fingers 30, and linkages 50 may be formed from any suitably ridged material such as aluminum, steel, steel-alloy, plastic, and the like. The overall length of pick-up tool 10 is typically dependent upon the type of environment (for example, household, office, medical facility, outdoor garden, roadside, beach, park, garage, golf course, tennis courts, and the like), in which the pick-up tool is to be used. Other applications include the retrieval of items from water (for example, swimming pools and ponds), and from elevated locations such as trees and building roofs and rafters. The pick-up tool may therefore be sized to accommodate such uses, and consequently may have an overall length of about 1-7 feet, or more.

The various components of handle 15 may be constructed using any suitably ridged material. For instance the handle may be formed from two injection-molded, half-handles, which are attached together with rivets, screws, adhesives, or other types of fasteners. The trigger may be constructed using similar materials.

If desired, various portions of handle 15 may be formed using a co-mold process, which is also known as over-molding. In general, a co-mold process is used to form a structure which has a relatively lower resistance to indentation relative to the surrounding structure. Simply put, a co-molded portion of a structure may be formed so that it is softer than surrounding structure to which it is attached or otherwise associated. As an example, polyurethane is often used as the co-mold material that is placed proximate to the relatively harder Acrylonitrile Butadiene Styrene (ABS).

In the embodiment of FIG. 1, trigger 45 includes co-molded portion 85 attached to base structure 87. Alone or in conjunction with recess 60, the co-molded portion allows for increased gripping power, and a comfortable location for the user to place their fingers. If desired, thumb tab 80 may also be formed using a co-molded process, thus providing a surface that has lower resistance to indentation for which the user can manipulate the locking mechanism.

Other portions of handle 15 may be formed using a co-molded process. Examples of such embodiments include the use of co-molding for side grip 88, one or more locations on grip 70 (for instance, the side of the grip that is in contact with the user's palm), the top side of platform 65, and the rear portion of platform 65, among others.

Operation of pick-up tool 10 according to an embodiment of the present invention will be now be described. Squeezing trigger 45 causes fingers 30 to move under bias pressure toward each other to grasp an item. An example of cups 40 and associated fingers and linkages in the closed position are shown in phantom in FIG. 1. Subsequently releasing the trigger causes the fingers to move away from each other and release the item. The trigger is typically positioned within the housing so that it pivots from a first position to a second of many possible positions. The first position may occur when the trigger is at the furthest point from grip 70, with fingers 30 spaced in the widest-apart position. A second position, which is shown in phantom, may occur when the trigger is pulled closer toward grip 70. This second position causes the fingers to move relatively closer to each other, thereby causing the cups to contact each other.

If desired, grip 70 may be designed so that trigger 45 is partially or completely received within a recess formed in the grip. Movement of fingers 30 and associated cups 40 can take place in any orientation about the plane of grip 70 and trigger 45, but these components typically operate in an arrangement that is substantially parallel or substantially perpendicular to the plane of the grip and trigger.

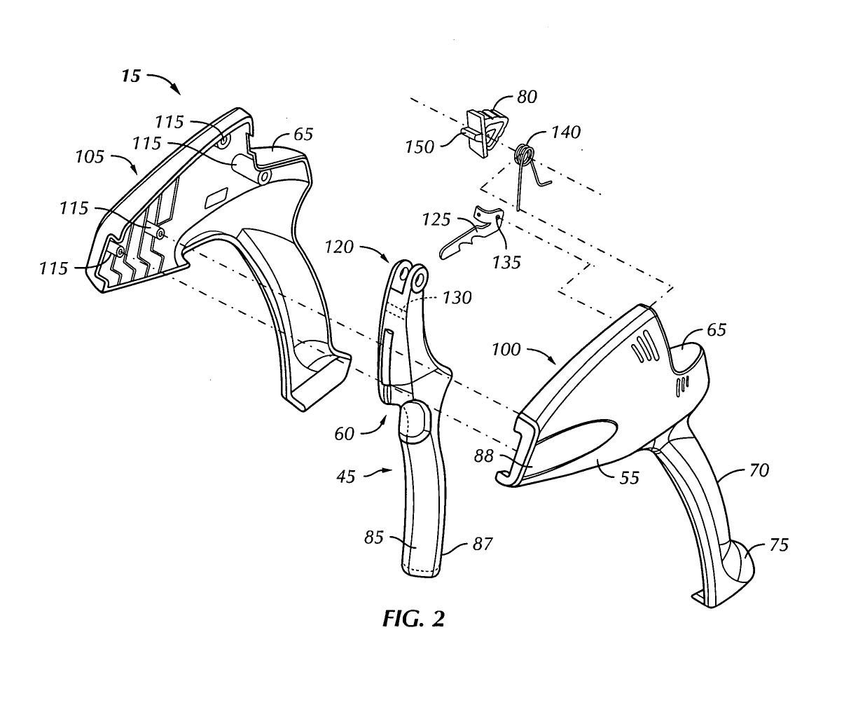

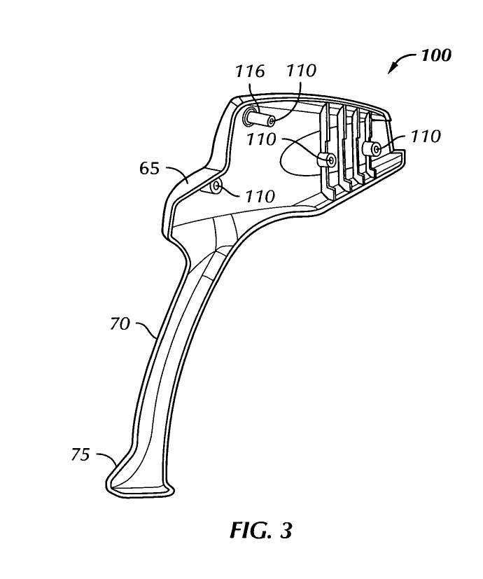

FIG. 2 is an exploded perspective view of handle 15 in accordance with an embodiment of the present invention. The handle includes first side panel 100 and second side panel 105. FIG. 3 is a side view of the interior of first side panel 100.

The side panels may be attached using known techniques, such as assembly pins and cooperating pin-receiving receptacles. FIGS. 2 and. 3 show a plurality of assembly pins 110, which are molded on the inside of first side panel 100. These assembly pins may be received by a plurality of assembly pin-receiving receptacles 115, which are correspondingly aligned on the inside of second side panel 105. Aperture 120 is shown formed at the proximal end of trigger 45. This aperture receives assembly pin 116, which is contained within side panel 100.

FIG. 2 also shows various components that may be implemented in an optional locking mechanism. Such components include locking pawl 125, which may be formed with one or more notches that are individually sized to receive pin 130. The locking pawl is shown formed with aperture 135, which is operatively coupled with torsion spring 140 once these components are assembled. The locking mechanism may further include sliding thumb tab 80, which is shown having engagement structure 150 for selectively engaging a leg of the torsion spring. As will be described in more detail herein, sliding the thumb tab downward ultimately causes one of the notches of the locking pawl to engage the pin and effectively lock the trigger in one of a plurality of different positions.

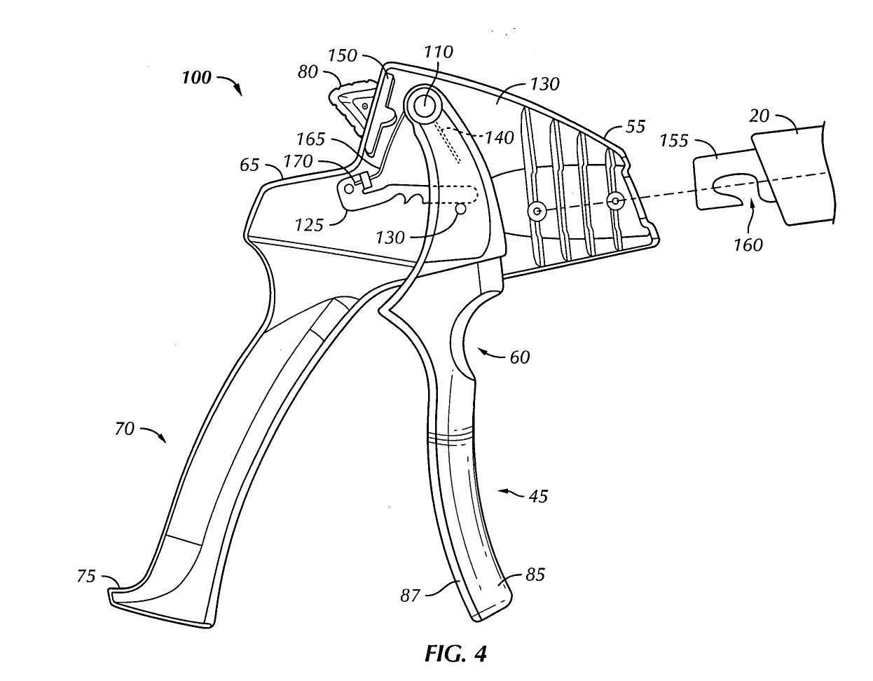

FIG. 4 is a side view of side panel 100, showing various components contained therein. Torsion spring 140 and the proximal end of trigger 45 are positioned on assembly pin 110. One leg of the torsion spring is in contact with the trigger, and locking pawl 125 is operatively coupled to the torsion spring. The side panel is also shown relative to the proximal end of body 20. Linkage 155 extends from the body and is used to operatively couple linkage 50 and trigger 45. Linkage 155 may be coupled to the trigger using known techniques. For example, linkage 155 may be formed with recess 160, which is sized to couple with pin 130. One alternative is to form a similar recess in the proximal end of each of linkages 50, and then couple linkages 50 to the trigger.

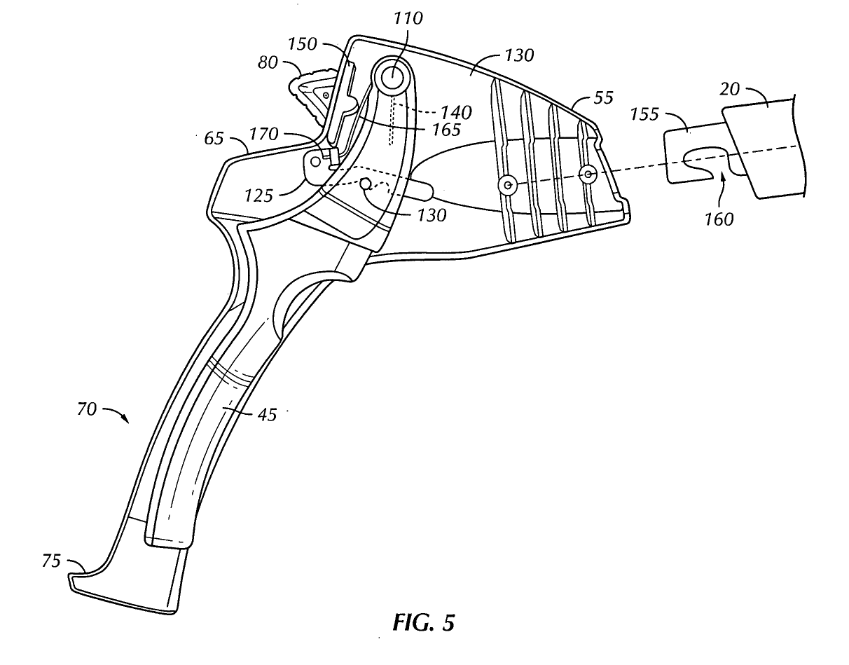

FIG. 5 is a side view of side panel 100, showing trigger 45 in the fully pulled-back position, within the recess of grip 70. Note further that the locking mechanism has been activated. Thumb tab 80 has been slid downward, causing engagement structure 150 to contact second leg 165, forcing this leg in a downward and forward direction. Consequently, third leg 170 forces locking pawl 125 downward until one of the notches of the locking pawl engages, for example, pin 130. The handle is now in the locked, and fully closed, position.

To unlock the handle, the user may use their thumb, for example, to slide thumb tab 80 upwards. The engagement structure disengages second leg 165, and the locking pawl 125 subsequently moves upward and out of contact with pin 130. The user can now release the trigger and it will be drawn away from grip 70, causing cups 40 to return to the fully open position. In a manner similar to that described above, the handle may be locked in a variety of different positions by virtue of the various notches formed in locking pawl 125.

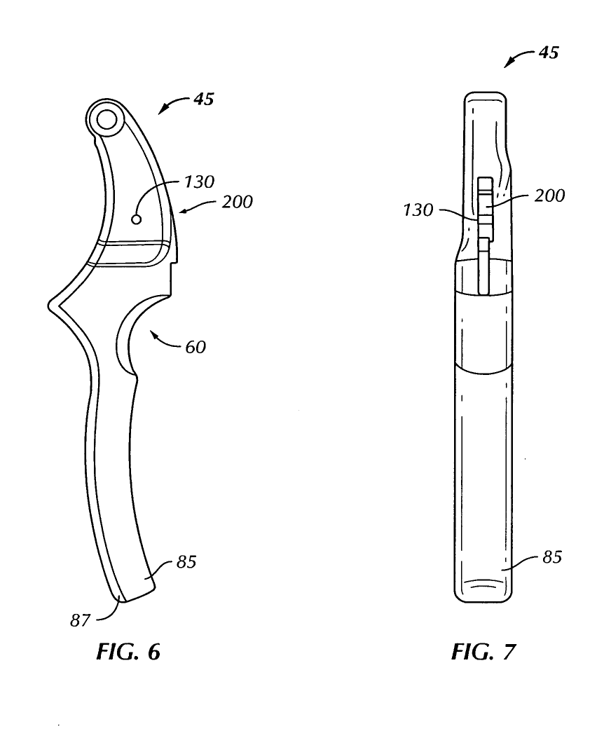

FIGS. 6 and 7 are side and front views, respectively, of trigger 45. The trigger includes slot 200, which permits linkage associated with the cups, such as linkage 155, to be received by the trigger and engage pin 130. Pin 130 may be formed from a sufficiently hard material such as metal or plastic. The slot also allows locking pawl 125 to pass through the trigger during the squeezing and releasing of the trigger, and for the locking pawl to engage pin 130 when the locking mechanism is operated (as discussed above).

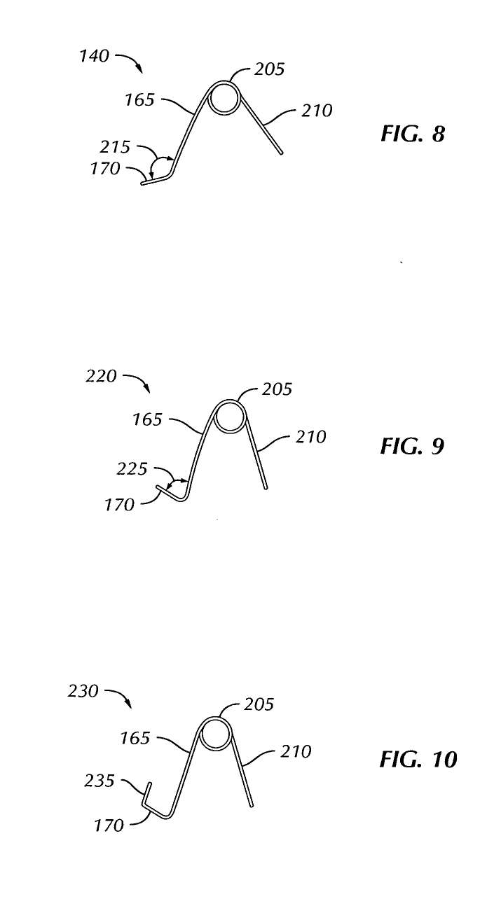

FIGS. 8-10 are side views of various torsion springs that may be implemented in handle 15. FIG. 8 depicts torsion spring 140, which includes center torque twist 205, first leg 210, second leg 165, and third leg 170. Angle 215 may be an obtuse angle of about 100°-130°. If desired, the angle defined by the second and third legs may be reduced to facilitate the coupling between the torsion spring and the locking pawl. FIG. 9 provides one such example and depicts torsion spring 220 configured with second and third legs that define angle 225, which is an acute angle of about 40°-90°.

FIG. 10 depicts torsion spring 230, which includes fourth leg 235. The fourth leg is useful for engaging the locking pawl during the locking process. If desired, fourth leg 235 may be implemented on any of the torsion springs disclose herein, including springs 140 and 220. Alternatively or additionally, the relative lengths of any of the legs disclosed herein may be changed (lengthened or shortened) if so desired.

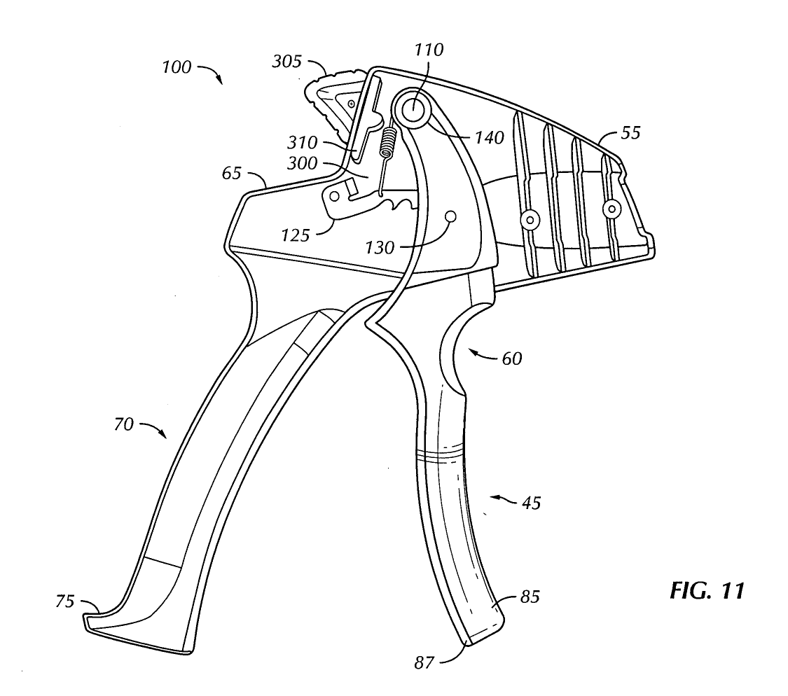

FIG. 11 is a side view of side panel 100 showing various components contained therein, including several components of a locking mechanism according to an alternative embodiment of the present invention. In this figure, coil spring 300 is shown positioned on assembly pin 110, and is connected to locking pawl 125. Trigger 45 may be locked in place by sliding thumb tab 305, causing engagement structure 310 to contact locking pawl 125. This action forces the pawl downward until one of the notches of the locking pawl engages, for example, pin 130. The handle is now in the locked, and fully closed, position.

To unlock the handle, the user may use their thumb to slide thumb tab 305 upwardly so that the engagement structure disengages locking pawl 125. Simultaneously, coil spring 300 retracts, causing the locking pawl to disengage pin 130. The user can now release the trigger and it will be drawn away from grip 70, resulting in trigger 45 returning to the fully open position.

While the invention has been described in detail with reference to disclosed embodiments, various modifications within the scope of the invention will be apparent to those of ordinary skill in this technological field. It is to be appreciated that features described with respect to one embodiment typically may be applied to other embodiments. Therefore, the invention properly is to be construed only with reference to the claims.

What is claimed is:

1. A handle for use with a pick-up tool, said handle comprising:
first and second side panels;
a pivoting trigger extending through an upper housing of said first and second side panels;
an integrated grip extending from a rear section of said upper housing; and
a locking mechanism associated with said handle, said locking mechanism comprising:
a pin located within a slot formed within said trigger;
a locking pawl comprising notches sized to be received by said pin;
a torsion spring comprising a first leg for coupling to said locking pawl; and
a sliding thumb tab located in said rear section of said upper housing, said thumb tab comprising an engagement structure designed to slideably engage said first leg of said torsion spring and cause one of said notches of said locking pawl to engage said pin and effectively lock said trigger.

2. The handle according to claim 1, wherein said trigger comprises:
a curved surface structured to receive fingers of a user; and
a recessed portion located proximate to said upper housing.

3. The handle according to claim 1, further comprising:
a platform formed in a rear section of said upper housing.

4. The handle according to claim 1, wherein said grip comprises:
a cavity structured to receive at least a portion of said trigger.

5. The handle according to claim 1, wherein said grip comprises:
a protruding structure located at a distal end of said grip and which extends from said grip to support a hand of a user.

6. The handle according to claim 1, wherein said trigger comprises:
co-molded material positioned to receive one or more fingers of a user.

7. The handle according to claim 6, wherein said trigger comprises Acrylonitrile Butadiene Styrene (ABS), and said co-molded material comprises polyurethane.

8. The handle according to claim 1, wherein said grip comprises:
co-molded material positioned to receive a palm of a user.

9. The handle according to claim 1, wherein each side panel of said first and second side panels comprise:
co-molded material located on outer portions of said first and second side panels.

10. The handle according to claim 1, wherein said torsion spring comprises:
a second leg that contacts said trigger; and
a third leg that cooperates with said first leg to engage said locking pawl.

11. The handle according to claim 1, wherein an obtuse angle is formed by said first leg and said third leg.

12. The handle according to claim 1, wherein an acute angle is formed by said first leg and said third leg.

13. A handle for use with a pick-up tool, said handle comprising:
first and second side panels;
a pivoting trigger extending through an upper housing of said first and second side panels;
an integrated grip extending from a rear section of said upper housing; and
a locking mechanism associated with said handle, said locking mechanism comprising:
a pin located within a slot formed within said trigger;
a locking pawl comprising notches sized to be received by said pin;
a coil spring coupled to said locking pawl; and
a sliding thumb tab located in said rear section of said upper housing, said thumb tab comprising an engagement structure designed to slideably engage said locking pawl and cause one of said notches of said locking pawl to engage said pin and effectively lock said trigger.

14. The handle according to claim 13, wherein said trigger comprises:
a curved surface structured to receive fingers of a user; and
a recessed portion located proximate to said upper housing.

15. The handle according to claim 13, wherein said trigger comprises:
co-molded material positioned to receive one or more fingers of a user.

16. The handle according to claim 13, wherein said grip comprises:
co-molded material positioned to receive a palm of a user.

17. A handle for use with a pick-up tool, said handle comprising:
first and second side panels;
a pivoting trigger extending through an upper housing of said first and second side panels;
an integrated grip extending from a rear section of said upper housing; and
a locking mechanism associated with said handle, said locking mechanism comprising:
a pin located within a slot formed within said trigger;
a locking pawl comprising notches sized to be received by said pin;
means for causing one of said notches of said locking pawl to engage said pin and effectively lock said trigger; and
means for retracting said locking pawl from said engagement with said pin.

18. A locking mechanism for use with a handle having a pivoting trigger, said locking mechanism comprising:
a pin located within a slot formed within said trigger;
a locking pawl comprising notches sized to be received by said pin;
a torsion spring comprising a first leg for coupling to said locking pawl;
a sliding thumb tab designed to be positionable within a rear section of said upper housing, said thumb tab comprising an engagement structure designed to slideably engage said first leg of said torsion spring and cause one of said notches of said locking pawl to engage said pin and effectively lock said trigger.

19. The locking mechanism according to claim 18, wherein said torsion spring comprises:
a second leg that contacts said trigger; and
a third leg that cooperates with said first leg to engage said locking pawl.

20. The locking mechanism according to claim 18, wherein an obtuse angle is formed by said first leg and said third leg.

21. The locking mechanism according to claim 18, wherein an acute angle is formed by said first leg and said third leg.

22. A pick-up tool, comprising:
an elongated body having first and second pick-up fingers extending divergently outward from a distal end of said body;
engagement elements individually located at terminating outer ends of each of said first and second pick-up fingers;
first and second linkages respectively extending from said first and second pick-up fingers;
a handle located at a proximal end of said body and structured to draw said first and second linkages rearward, causing said engagement elements to move closer together, wherein said handle comprises:
first and second side panels;
a pivoting trigger extending through an upper housing of said first and second side panels;
an integrated grip extending from a rear section of said upper housing;
a locking mechanism associated with said handle, said locking mechanism comprising:
a pin located within a slot formed within said trigger;
a locking pawl comprising notches sized to be received by said pin;
a torsion spring comprising a first leg for coupling to said locking pawl; and
a sliding thumb tab located in said rear section of said upper housing, said thumb tab comprising an engagement structure designed to slideably engage said first leg of said torsion spring and cause one of said notches of said locking pawl to engage said pin and effectively lock said trigger.

23. The pick-up tool according to 22, wherein said engagement elements each include a rubber cup.

24. The pick-up tool according to 22, wherein said body is formed from plastic.

25. The pick-up tool according to 22, wherein said body is formed from aluminum.
